(19) United States
(12) Patent Application Publication
(10) Pub. No.: US 2026/0131793 A1
(43) Pub. Date: May 14, 2026

(54) VEHICLE CONTROL DEVICE, VEHICLE CONTROL METHOD, AND NON-TRANSITORY COMPUTER-READABLE STORAGE MEDIUM

(71) Applicant: HONDA MOTOR CO., LTD., Tokyo (JP)

(72) Inventor: Takuma KOBAYASHI, Tokyo (JP)

(21) Appl. No.: 19/369,833

(22) Filed: Oct. 27, 2025

(30) Foreign Application Priority Data
Nov. 8, 2024 (JP) 2024-195912

(51) Int. Cl. B60W 40/08; B60W 30/08

(52) U.S. Cl. CPC B60W 40/08; B60W 30/08; B60W 2540/106; B60W 2540/12

(57) ABSTRACT

A vehicle control device 1 includes: a driver state recognizer 55 that recognizes a state of a driver of a vehicle 2, a driver state determiner 56 that determines that the state of the driver is abnormal when the state of the driver does not satisfy a prescribed suitability criterion based on a recognition result of the driver state recognizer 55; an operation detector 58 that detects an operation on a driving operation member which constitutes the driving operation device 17 of the vehicle 2; and a travel controller 52 that executes travel control of the vehicle 2 based on the operation detected by the operation detector 58 and a determination result of the driver state determiner 56. The driver state determiner 56 relaxes the suitability criterion when the operation detector 58 detects a specific operation.

### TECHNICAL FIELD

The present invention relates to a vehicle control device that controls the traveling of a vehicle and more specifically, to a vehicle control device that executes travel control of the vehicle based on a state of a driver of the vehicle, a vehicle control method, and a non-transitory computer-readable storage medium.

### BACKGROUND ART

In recent years, efforts have been actively made to provide access to sustainable transport systems that take into account people in vulnerable situations among traffic participants. To achieve this, research and development for further improving safety and convenience of traffic through development of driving assistance technologies is attracting attention.

Conventionally, a surrounding detector that detects a surrounding situation of the vehicle, and a travel controller that controls the travel of the vehicle based on the detection results of the surrounding detector have been provided. For example, JP2024-8140A discloses a vehicle control device that executes travel control including a following-travel control for causing the vehicle to follow a preceding vehicle based on the surrounding situation of the vehicle, and executes emergency control when an abnormal state of the driver is detected from a facial image of the driver captured by a driver camera (an in-vehicle camera) while the vehicle is traveling.

JP2019-191754A discloses a driver state determiner that determines the state of the driver driving the vehicle. The driver state determiner includes a steering torque sensor and a pedal sensor that detects an operation amount of the operating pedal, and when the operation amount of the pedal changes by more than the prescribed amount while the steering torque changes by more than a first threshold value, the driver state determiner determines that the state of the driver is abnormal.

JP2022-144818A discloses a driving assistance device that cancels the execution of autonomous stopping control in response to the operation by the driver. The device executes the autonomous stopping control to decelerate and stop the vehicle based on whether it is detected that the driver is in an incapacitated state. The device also includes an operation state detector that detects the operation state of the operation member of the vehicle, and when the device detects that the operation state of the operation member has changed a plurality of times while the autonomous stopping control is being executed, the device cancels the execution of the autonomous stopping control. The change in the operation state is detected by a transition between a depressed state of the pedal and a released state of the pedal.

However, when the abnormality (abnormal state) of the driver is determined from the driver camera, as in the conventional technique described above, the determination accuracy of the abnormal state is low. Accordingly, the abnormal state of the driver may be excessively determined, and notification of the detection of the abnormal state may be excessively performed. To suppress excessive determination of the abnormal state of the driver, the abnormal state of the driver may be determined carefully. However, this increases the time required for determining the abnormal state of the driver, and the determination is delayed when the driver is actually in an abnormal state.

### SUMMARY OF THE INVENTION

In view of the above background, an object of the present invention is to suppress excessive determination of the abnormal state of the driver and to more appropriately determine the abnormal state of the driver.

To achieve such an object, one aspect of the present invention provides a vehicle control device including: a driver state recognizer configured to recognize a state of a driver of a vehicle a driver state determiner configured to determine that the state of the driver is abnormal when the state of the driver does not satisfy a prescribed suitability criterion based on a recognition result of the driver state recognizer; an operation detector configured to detect an operation on a driving operation member of the vehicle, and a travel controller configured to execute travel control of the vehicle based on the operation detected by the operation detector and a determination result of the driver state determiner. The driver state determiner is configured to modify the suitability criterion so that the suitability criterion is relaxed in a case where the operation detector detects a specific operation in which the driving operation member is operated in a first direction and then in a second direction opposite to the first direction.

Thus, according to the above aspects, it is possible to suppress excessive determination of the abnormal state of the driver and to more appropriately determine the abnormal state of the driver.

### BRIEF DESCRIPTION OF THE DRAWING(S)

FIG. 1 is a block diagram of a vehicle system according to an embodiment of the present invention;

FIG. 2 shows an image captured by an in-vehicle camera;

FIG. 3A is an explanatory diagram of an example of an inappropriate driving state in the image captured by the in-vehicle camera;

FIG. 3B is an explanatory diagram of an example of an inappropriate driving state in the image captured by the in-vehicle camera;

FIG. 4 is a time chart showing an example of a specific operation;

FIG. 5 is a time chart showing an example of an operation other than the specific operation;

FIG. 6 is a time chart showing an operation amount of the operation other than the specific operation;

FIG. 7 is a time chart showing an operation speed of the operation shown in FIG. 6;

FIG. 8 is a flowchart showing a procedure for travel assistance control by a vehicle control device;

FIG. 9 is a time chart of an example of the travel assistance control when the specific operation is not detected; and

FIG. 10 is a time chart of an example of the travel assistance control when the specific operation is detected.

### DETAILED DESCRIPTION OF THE INVENTION

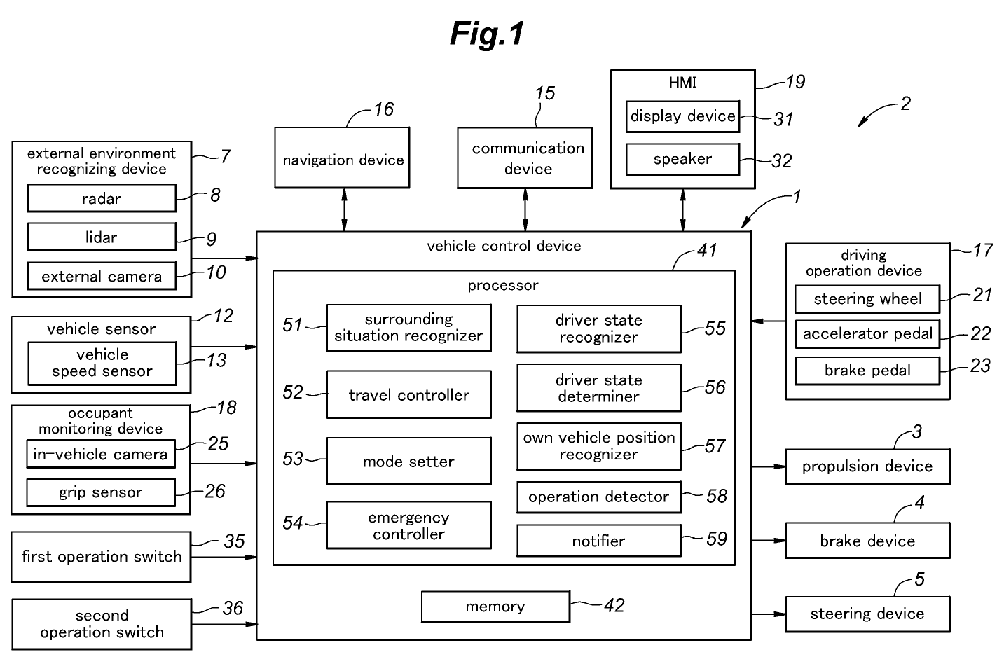

As shown in FIG. 1, a vehicle control device 1 is provided in a vehicle 2. The vehicle 2 may be, for example, a four-wheeled automobile. The vehicle 2 is an autonomous driving vehicle or a vehicle with a driving assistance function.

The vehicle 2 includes a propulsion device 3, a brake device 4, and a steering device 5. The propulsion device 3 is a device that provides the driving force to the vehicle 2, and includes, for example, a power source and a transmission. The power source includes at least one of an internal combustion engine such as a gasoline engine or a diesel engine and an electric motor. The brake device 4 is a device that applies the braking force to the vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism The propulsion device 3, the brake device 4, and the steering device 5 are controlled by the vehicle control device 1.

The vehicle 2 includes an external environment recognizing device 7. The external environment recognizing device 7 is a device for detecting objects outside the vehicle 2 and the like. The external environment recognizing device 7 is a sensor that captures electromagnetic waves and light from the surroundings of the vehicle 2 to detect the objects outside the vehicle 2. The external environment recognizing device 7 includes, for example, a radar 8, a lidar 9 (LIDAR), and an external camera 10.

The vehicle 2 includes a vehicle sensor 12. The vehicle sensor 12 includes a vehicle speed sensor 13 that detects the speed of the vehicle 2, an acceleration sensor that detects the acceleration thereof, a yaw rate sensor that detects the angular velocity around the vertical axis, an azimuth sensor that detects the orientation of the vehicle 2, and the like.

The vehicle 2 includes a communication device 15, a navigation device 16, a driving operation device 17, an occupant monitoring device 18, and an HMI 19 (Human Machine Interface). The communication device 15 mediates communication between the components (for example, the vehicle control device 1 and the navigation device 16) of the vehicle 2 and the devices (for example a surrounding vehicle and a server) arranged outside the vehicle 2.

The navigation device 16 is a device that acquires the current position of the vehicle 2 and provides route guidance to the destination, and the like. The navigation device 16 may include a GNSS receiving unit, a map storage unit, a navigation interface, and a route determination unit. The GNSS receiving unit determines the position (latitude and longitude) of the vehicle 2 based on signals received from artificial satellites (positioning satellites). The map storage unit is composed of a known storage device such as flash memory or a hard disk, and stores map information. The navigation interface accepts the input of information such as the destination by the occupant, and presents various information to the occupant via display and audio. The navigation interface may include, for example, a touch panel display, a speaker 32, and the like.

The driving operation device 17 accepts input operations performed by the occupant (driver) to control the vehicle 2. The driving operation device 17 includes a steering wheel 21, an accelerator pedal 22, and a brake pedal 23. The driving operation device 17 may also include a shift lever, a parking brake lever, and the like. Each component of the driving operation device 17 is provided with a sensor that detects the operation amount. The driving operation device 17 outputs a signal indicating the operation amount to the vehicle control device 1.

The occupant monitoring device 18 monitors the state of the occupant inside a vehicle cabin. The occupant monitoring device 18 includes, for example, an in-vehicle camera 25 that captures an image of the occupant seated on a seat inside the vehicle cabin, and a grip sensor 26 provided on the steering wheel 21. The in-vehicle camera 25 is a digital camera that uses a solid-state image sensor such as a CCD or CMOS. The grip sensor 26 detects whether the driver is gripping the steering wheel 21. The grip sensor 26 may be formed, for example, of a capacitance sensor or a piezoelectric element provided on the steering wheel 21.

The HMI 19 notifies the occupant of various information by display and audio, and accepts input operations by the occupant. The HMI 19 includes the display device 31 and the speaker 32. The display device 31 may be a touch panel display including a liquid crystal display or an organic electroluminescence display. The display device 31 may also function as a navigation interface. The display device 31 and the speaker 32 function as notification devices for notifying the occupant by images and audio. Here, the image may be a video including a number of consecutive frames. The HMI 19 may also include various actuators. For example, the actuator may be configured to act on the six senses of the driver, such as a vibration actuator incorporated into the steering wheel 21 or a belt tightening device incorporated into a seat belt retractor.

The vehicle 2 includes a first operation switch 35 and a second operation switch 36. The first operation switch 35 and the second operation switch 36 are switches that can be operated by the occupant. The first operation switch 35 and the second operation switch 36 may be mechanical switches or GUI switches displayed on a touch panel, and are arranged at appropriate positions inside the vehicle cabin. The first operation switch 35 and the second operation switch 36 may be composed of the display device 31 or the navigation interface. The first operation switch 35 may be a switch for turning on and off the driving assistance control. The second operation switch 36 is preferably a switch for selecting a driving assistance control to be executed from the driving assistance control of plural types, and for setting the level of autonomous driving. The second operation switch 36 may be, for example, a rotary switch. The first operation switch 35 and the second operation switch 36 may be integrated into a common switch.

The vehicle control device 1 is a computer including a processor 41 and a memory 42 communicatively connected to the processor 41. The processor 41 may include at least one of the following cores a central processing unit (CPU), a graphics processing unit (GPU), and a reduced instruction set computer (RISC). The memory 42 stores the control program executed by the processor 41 and various data. The memory 42 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle control device 1 may be realized by hardware such as a large scale integration (LSI), an application specific integrated circuit (ASIC), or a field-programmable gate array (FPGA), or may be realized by a combination of software and hardware. The vehicle control device 1 may be composed of a single piece of hardware, or may be composed of plural pieces of hardware capable of communicating with each other. A portion of the vehicle control device 1 may be composed of an external server provided outside the vehicle 2.

The processor 41 realizes various applications by executing the control program stored in the memory 42. The control program may be stored in a removable recordable medium such as a DVD or a CD-ROM, and installed in the memory 42 as the recordable medium is read by a reading device. The control program may also be downloaded and installed in the memory 42 via a communication network such as the Internet.

By executing the control programs stored in the memory 42, the processor 41 functions as a surrounding situation recognizer 51, a travel controller 52, a mode setter 53, an emergency controller 54, a driver state recognizer 55, a driver state determiner 56, an own vehicle position recognizer 57, an operation detector 58, and a notifier 59. The processor 41 executes the control program, and the vehicle control device 1, which is a computer, executes the vehicle control method. The memory 42 functions as a non-transitory computer-readable storage medium comprising the control program. The control program, when executed by the processor 41 of the vehicle control device 1, executes the vehicle control method.

The surrounding situation recognizer 51 recognizes the surrounding situation of the vehicle 2. The surrounding situation recognizer 51 recognizes the surrounding situation (external environment), including obstacles located around the vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The surrounding situation recognizer 51 can acquire the position, speed, acceleration, and other states of the surrounding vehicles from the detection results of the external environment recognizing device 7.

The own vehicle position recognizer 57 recognizes the lane in which the vehicle 2 is traveling and the relative position and angle of the vehicle 2 with respect to the lane in which the vehicle 2 is traveling. The own vehicle position recognizer 57 may recognize the traveling lane based on the map information and the position of the vehicle 2 acquired by the GNSS receiving unit. Further, the own vehicle position recognizer 57 extracts the dividing lines around the vehicle 2 drawn on the road surface from the map information, and compares the dividing lines from the map information with the shapes of the dividing lines captured by the external camera 10, thereby recognizes the relative position and angle of the vehicle 2 with respect to the traveling lane.

The driver state recognizer 55 recognizes the situation of the driver. The driver state recognizer 55 recognizes the state of the driver and the holding state of the steering wheel 21 by the driver based on the detection result of the occupant monitoring device 18. The state of the driver includes the position of the head, the orientation of the face, the open/closed state of the eyes, and the direction of the sight-line of the driver. The driver state recognizer 55 can acquire such state information of the driver from the detection results of the in-vehicle camera 25.

The driver state determiner 56 determines the state of the driver. The driver state determiner 56 determines, based on a signal from the occupant monitoring device 18, whether the state of the driver is a surrounding monitoring state. The surrounding monitoring state is a state suitable for driving, in which the driver monitors the surroundings of the vehicle 2 and satisfies prescribed suitability criteria. This state is required for autonomous driving of level 2 or lower, where the driver has a duty to monitor the surroundings. In the surrounding monitoring state, it is preferable that the driver is in a state where the driver can start manual driving quickly. For example, in the surrounding monitoring state the driver is seated on the seat facing forward and monitors the area in front of the vehicle 2. The driver state determiner 56 may, for example, acquire the posture or head orientation of the driver based on an image from the in-vehicle camera 25, and determine that the state of the driver is the surrounding monitoring state in a case where the posture or head orientation of the driver corresponds to a prescribed surrounding monitoring posture. Further, the driver state determiner 56 may, for example, acquire the sight-line of the driver based on an image from the in-vehicle camera 25, and determine that the state of the driver is the surrounding monitoring state that satisfies the suitability criteria in a case where the sight-line of the driver is directed forward. Further, the driver state determiner 56 may determine that the state of the driver is the surrounding monitoring state in a case where the steering wheel 21 is gripped by the driver based on a signal from the grip sensor 26. Further, the driver state determiner 56 may determine that the state of the driver is the surrounding monitoring state in a case where the sight-line of the driver is directed forward and the steering wheel 21 is gripped by the driver.

In the autonomous driving of level 3 or higher, where the driver does not have a duty to monitor the surroundings, an abnormal state means a state in which the driver is unable to quickly take over driving when a takeover request is issued. The state in which the driver is unable to take over driving is a state in which the driver is unable to monitor a screen display that displays a warning, and includes a state in which the driver is asleep or looking backward. In the present embodiment, in the autonomous driving of level 3, the suitability criteria include conditions for ensuring that the driver fulfills the duty of monitoring the surroundings of the vehicle when the driver is notified to do so.

At each level of autonomous driving, in a case where the prescribed suitability criteria are not satisfied, the driver state determiner 56 determines that the driver is not in a normal state according to the autonomous driving level and determines the state of the driver as abnormal.

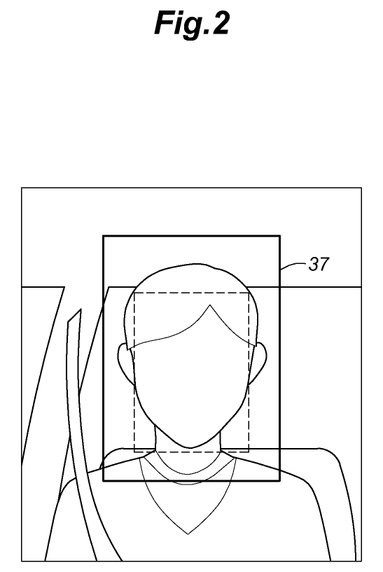

FIG. 2 shows an image taken by the in-vehicle camera 25. As shown in FIG. 2, the driver state determiner 56 sets the prescribed area 37 in the image of the driver's seat captured by the in-vehicle camera 25, the prescribed area 37 being an area where the head of the driver should be located during driving. In the present embodiment, the driver state determiner 56 sets the prescribed area 37 as a vertically elongated rectangular shape. In other embodiments, the prescribed area 37 may be set in a shape other than a rectangle. The position and size of the prescribed area 37 may be appropriately set according to the position and size of the head of the driver seated in the driver's seat. The shape of the prescribed area 37 may also be set according to the shape of head of the driver.

The driver state determiner 56 analyzes the images captured by the in-vehicle camera 25 and sequentially detects the head of the driver. More specifically, the driver state determiner 56 extracts edges representing the outline of the face of the driver from the image of the driver's seat, and detects a rectangular area, surrounded by vertical lines passing through the left and right ends of the extracted edges and horizontal lines passing through the top and bottom ends of the edges as the head (face). The prescribed area 37 is set to a size obtained by adding prescribed margins to the left and right and above and below the detected head. When the driver is in the surrounding monitoring state, the face of the driver is positioned substantially in the center of the prescribed area 37. The driver state determiner 56 acquires the trajectory of the head of the driver based on the sequentially detected positions of the head of the driver.

The driver state determiner 56 also detects facial features such as the eyes, nose, and mouth from the face of the driver. The driver state determiner 56 detects the orientation of the face of the driver based on the outline of the face and the positions of the facial features of the driver. The orientation of the face is calculated as a deflection direction and a deflection degree (angle) relative to the forward direction toward which the face of the driver should be oriented during driving. The driver state determiner 56 acquires a change in the orientation of the face of the driver based on the sequentially detected orientations of the face of the driver.

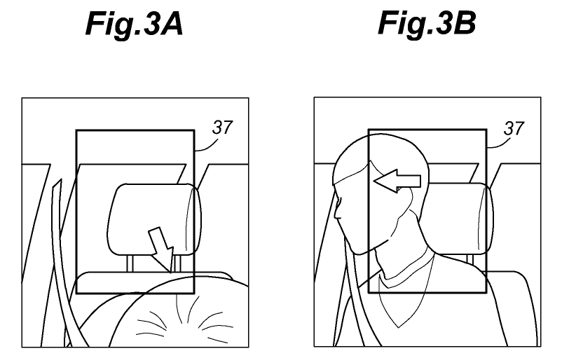

FIGS. 3A and 3B are explanatory diagrams of the change in the position of the head in the image captured by the in-vehicle camera 25. The driver in the surrounding monitoring state as shown in FIG. 2 may significantly tilt the head forward as shown in FIG. 3A. For example this may occur when the driver suddenly becomes ill. In this case, the driver state determiner 56 detects that the head of the driver has moved out of the prescribed area 37 in the downward direction, and determines that the driver is in an inappropriate state that fails to satisfy the suitability criteria according to the autonomous driving level.

As shown in FIG. 3B, the driver may move the head laterally during driving. For example, this may occur when the driver visually checks the line marking through a side window or checks the rear of the vehicle 2 by direct vision. In this case, the driver state determiner 56 detects that the head of the driver has moved out of the prescribed area 37 in the vehicle width direction as shown in FIG. 3B, and determines that the state of the driver is inappropriate that fails to satisfy the prescribed suitability criteria.

In this way, the driver state determiner 56 determines that the driver is in the inappropriate state when at least one of the prescribed conditions set in the suitability criteria is not satisfied. When the inappropriate state continues for the prescribed time threshold, the driver state determiner 56 determines that the state of the driver is abnormal. The driver state determiner 56 determines that the state of the driver is normal unless the inappropriate state continues for the prescribed time threshold. Further, even if the state of the driver has once been determined as abnormal, when the state of the driver returns from the inappropriate state to the appropriate state such as a surrounding monitoring state, the driver state determiner 56 determines that the state of the driver is normal.

Returning to FIG. 1, the description will be continued. The operation detector 58 acquires the operation amount of the driving operation device 17 based on a signal from the driving operation device 17. The operation detector 58 acquires the operation amount of the brake pedal 23, the accelerator pedal 22, and the steering wheel 21 based on signals from sensors provided on the brake pedal 23, the accelerator pedal 22, and the steering wheel 21. That is, the operation detector 58 is configured to be able to detect the operation of the brake pedal, the accelerator pedal, and the steering wheel by the driver.

The operation detector 58 is configured to detect the operations on the first operation switch 35 and the second operation switch 36 by the occupant based on signals from the first operation switch 35 and the second operation switch 36.

The travel controller 52 is configured to control the acceleration and deceleration of the vehicle 2 according to the driving mode. The travel controller 52 may also be configured to control the steering of the vehicle 2 in addition to the acceleration and deceleration of the vehicle 2. The travel controller 52 executes autonomous driving control including adaptive cruise control (hereinafter referred to as ACC) and lane keeping assist control (Lane Keeping Assist System, hereinafter referred to as LKAS). The adaptive cruise control is an example of vehicle speed control that controls the acceleration and deceleration of the vehicle 2 to control the vehicle speed of the vehicle 2. The travel controller 52 controls the propulsion device 3 and the brake device 4 to control the acceleration and deceleration of the vehicle 2 and assist the driver in driving. Further, the lane keeping assist control is an example of steering control that controls the steering device 5 to control the steering of the vehicle 2. The travel controller 52 controls the steering device 5 to control the trajectory of the vehicle 2 and assist the driver in driving.

In addition to the above-mentioned controls that assist driving during normal travel the travel controller 52 also executes autonomous driving control to prevent accidents, such as a collision mitigation braking system (hereinafter referred to as CMBS) and a lane departure prevention function. The CMBS is realized by controlling the brake device 4 to decelerate the vehicle 2 after issuing a warning, to avoid or mitigate the collision when there is a risk that the vehicle 2 collides with a preceding vehicle or a pedestrian. The lane departure prevention function is realized by controlling the steering device 5 to change the traveling direction of the vehicle 2 after issuing a warning, when there is a risk that the vehicle 2 deviates from the driving lane.

When the operation detector 58 detects an ON signal from the first operation switch 35, the travel controller 52 starts the driving assistance control. When the operation detector 58 detects the OFF signal from the first operation switch 35, the travel controller 52 terminates the driving assistance control. When the operation detector 58 detects the selection signal from the second operation switch 36, the travel controller 52 switches the driving assistance control to be executed or currently being executed to the driving assistance control selected by the selection signal. The selection signal from the second operation switch 36 includes, for example, a signal that selects ACC and LKAS, and a signal that selects only LKAS.

The mode setter 53 is configured to change the driving mode. The driving mode includes a manual driving mode, a driving assistance mode during travel, and a driving assistance mode during stop. The driving assistance modes during travel include the autonomous driving level 1 mode, the autonomous driving level 2 mode, the autonomous driving level 3 mode, the accelerator pedal override mode (hereinafter referred to as APOR mode), or the like. The autonomous driving level 1 mode is a mode in which a degree of driving task imposed on the driver is greater than that in the autonomous driving level 2 mode, or a degree of driving assistance provided to the driver is smaller than that in the autonomous driving level 2 mode. The autonomous driving level 2 mode is a mode in which a degree of driving task imposed on the driver is greater than that in the autonomous driving level 3 mode, or a degree of driving assistance provided to the driver is smaller than that in the autonomous driving level 3 mode. The driving assistance mode during stop includes a start standby mode and a stop hold mode. The driving mode transitions according to the operation by the occupant, the state of the vehicle 2, and the state of the occupant.

In the manual driving mode, the travel controller 52 controls the vehicle 2 based on the driving operations of the driver. More specifically, in the manual driving mode, the travel controller 52 acquires the operation amount of the brake pedal 23 from the brake pedal 23 and controls the brake device 4 based on the operation amount of the brake pedal 23. Further, in the manual driving mode, the travel controller 52 acquires the operation amount of the accelerator pedal 22 from the accelerator pedal 22 and controls the propulsion device 3 based on the operation amount of the accelerator pedal 22. Further, in the manual driving mode, the travel controller 52 acquires the operation amount of the steering wheel 21 from the steering wheel 21 and controls the steering device 5 based on the operation amount of the steering wheel 21.

The driving assistance mode can be set when the vehicle 2 is traveling When the LKAS is selected in the driving assistance mode, the travel controller 52 executes the lane keeping assistance control to cause the vehicle 2 to travel along the lane. The lane information is included in the surrounding situation recognized by the surrounding situation recognizer 51.

Further, when ACC is selected in the driving assistance mode, the travel controller 52 controls the acceleration and deceleration of the vehicle 2 according to the surrounding situation, in addition to the control of the LKAS. In another embodiment, control of ACC and LKAS may be executed independently. The surrounding situations include, for example, a preceding vehicle traveling in front of the vehicle 2. In the driving assistance mode, the travel controller 52 controls the propulsion device 3 and the brake device 4 so as to maintain the inter-vehicle distance between the vehicle 2 and the preceding vehicle traveling in front of the vehicle 2 equal to or more than a prescribed value, and to maintain the vehicle speed at a target vehicle speed within a range in which the inter-vehicle distance can be maintained. The travel controller 52 acquires the position and speed of the preceding vehicle based on the surrounding situations acquired by the surrounding situation recognizer 51. The target vehicle speed may be set by the driver. The target vehicle speed may be set by the operation on the display device 31 or the operation switch by the driver. Further, in the driving assistance mode, the travel controller 52 may control the propulsion device 3 and the brake device 4 based on signal information about traffic lights and sign information acquired by the surrounding situation recognizer 51.

The APOR mode is set as the accelerator pedal 22 is pressed when the driving mode is the driving assistance mode In the APOR mode, the travel controller 52 controls the propulsion device 3 based on the pressing amount applied to the accelerator pedal 22. This enables the vehicle 2 to accelerate according to the accelerator pedal operation by the driver.

In the driving assistance mode, when the preceding vehicle decelerates and stops, the travel controller 52 stops the vehicle 2 while maintaining the inter-vehicle distance between the vehicle 2 and the preceding vehicle. Further, in the driving assistance mode, the travel controller 52 may acquire traffic light information and stop the vehicle 2 at a stop line according to the traffic light information.

Further, when LKAS is selected in the driving assistance mode, the travel controller 52 executes the lane keeping assist control to cause the vehicle 2 to travel along the lane, in addition to the ACC described above. The travel controller 52 executes the travel control based on the determination result of the driver state determiner 56.

The notifier 59 makes a notification to the driver via the HMI 19 when the driver state determiner 56 determines that the state of the driver is abnormal.

When the driver state determiner 56 determines that the state of the driver is abnormal, the emergency controller 54 executes emergency control to ensure the safety of the vehicle 2 and the driver. The emergency control is executed regardless of the driving level or the driving state of the vehicle 2. For example, the emergency control is executed while the vehicle 2 is stopped, while the vehicle 2 is traveling, while the ACC or the LKAS is executed, or while the ACC and the LKAS are simultaneously executed. The emergency control takes precedence over the driving operation by the driver and the driving assistance control executed by the travel controller 52, as described below. When the state of the driver is determined to be abnormal, the emergency controller 54 executes the following controls: in-vehicle notification to the occupant, suppression of acceleration of the vehicle 2, and lane keeping control. If the abnormal state of the driver continues thereafter, the emergency controller 54 confirms the abnormal state of the driver and executes the following controls: external notification deceleration of the vehicle 2, and lane change control to bring the vehicle 2 to a stop in the traveling lane or on the road shoulder. After the vehicle 2 is brought to a stop, the emergency controller 54 executes controls for contacting a hospital or the like and for maintaining the stopped state of the vehicle.

The vehicle control device 1 is configured as described above. The vehicle control device 1 according to the present embodiment is configured to modify the criteria used to determine the abnormality abnormal state of the driver, since the determination accuracy of the abnormal state is low when the abnormal state of the driver is determined only from an image of the in-vehicle camera 25 that captures the driver. More specifically, the driver state determiner 56 modifies the suitability criteria so that the suitability criteria are relaxed when the specific operation is detected by the operation detector 58.

The specific operation is an operation that is likely to have been performed by the driver in a normal state, and is an operation in which one of the driving operation members of the driving operation device 17 is operated in a first direction and then in a second direction opposite to the first direction. In the present embodiment, the driver state determiner 56 relaxes the suitability criteria by modifying the duration of the inappropriate state in the suitability criteria to a larger value, when the specific operation is detected. Accordingly, it is possible to suppress excessive determination of the abnormal state of the driver, and to more appropriately determine the abnormal state of the driver.

When the driver experiences a seizure and becomes rigid, or when the driver loses consciousness and becomes relaxed, the driver may operate the driving operation member with a large or small operation force. Such an operation should be excluded from the specific operation. In other words, when such an operation is performed, it is necessary to appropriately (specifically early or sensitively) determine the abnormal state of the driver, without relaxing the suitability criteria. Accordingly, the specific operation is set so as to exclude operations that may occur when the driver is in such an abnormal state.

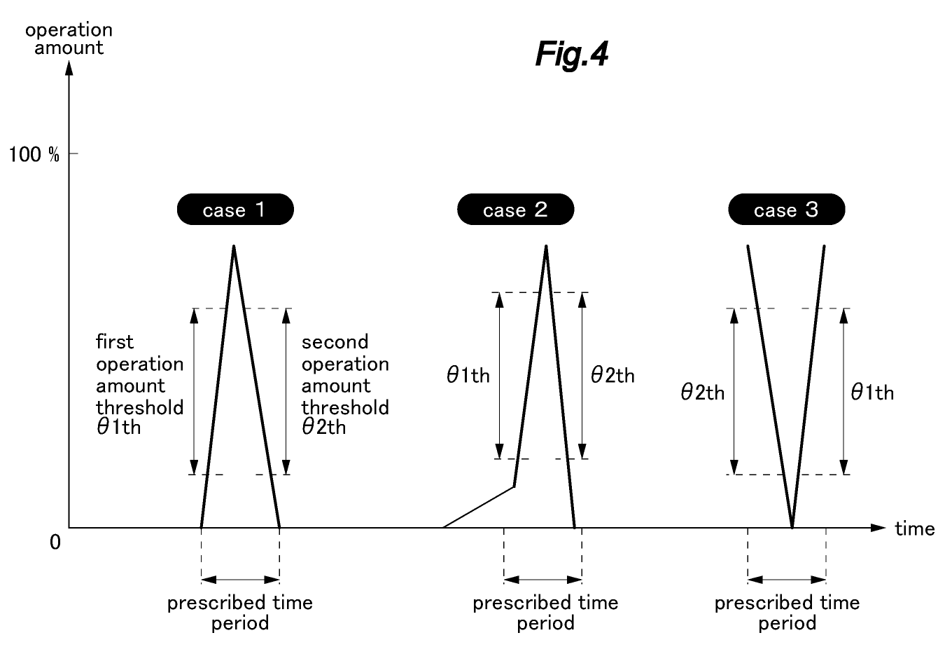

The specific operation will be described with reference to FIGS. 4 to 7. The operating member for detecting the specific operation may be any driving operating member, such as the steering wheel 21, the accelerator pedal 22, and the brake pedal 23. With respect to the steering wheel 21, the operation in the first direction may be, for example, the clockwise steering, in which case the operation in the second direction is the counterclockwise steering, or vice versa With respect to the accelerator pedal 22 and the brake pedal 23, the operation in the first direction may be, for example, a depression of the pedal, in which case the operation in the second direction is a release of the pedal, or vice versa. Here the operation in the first direction and the operation in the second direction refer to operations performed on a single operation member.

FIG. 4 is a time chart showing an example of the specific operation The first operation amount threshold θ1th, which is a threshold for the operation in the first direction, is set as a condition for the specific operation. Further, the second operation amount threshold θ2th, which is a threshold for the operation in the second direction, is set as a condition for the specific operation. In the present embodiment the first operation amount threshold θ1th and the second operation amount threshold θ2th have the same value, but are not limited thereto. In another embodiment, the first operation amount threshold θ1th and the second operation amount threshold θ2th may have different values. As shown in FIG. 4, the prescribed time period is set as a condition for detecting the operation in the first direction and the operation in the second direction in the specific operation. Based on the conditions, it is determined whether a series of operations performed by the driver is a specific operation.

FIG. 4 shows the operations for three cases, each of which satisfies the conditions of the specific operation. The cases 1 and 2 are a series of operations in which an operation in a first direction (in this case, the direction in which the operation amount increases) is followed by an operation in a second direction (in this case the direction in which the operation amount decreases). The operation in the first direction and the operation in the second direction may be separated in time. In either case, an operation in the first direction with an operation amount equal to or greater than the first operation amount threshold θ1th, and a subsequent operation in the second direction with an operation amount equal to or greater than the second operation amount threshold θ2th, are performed within the prescribed time period. Case 3 is a series of operations in which an operation in the second direction is followed by an operation in the first direction. In this case, the operation in the second direction and the operation in the first direction may be separated in time. In Case 3, an operation in the second direction with an operation amount equal to or greater than the second operation amount threshold θ2th, and a subsequent operation in the first direction with an operation amount equal to or greater than the first operation amount threshold θ1th, are performed within the prescribed time period. It is likely that the operations for the three cases are intentionally performed by a driver in a normal state. In other words, the operations are unlikely to have been performed due to the driver entering an abnormal state.

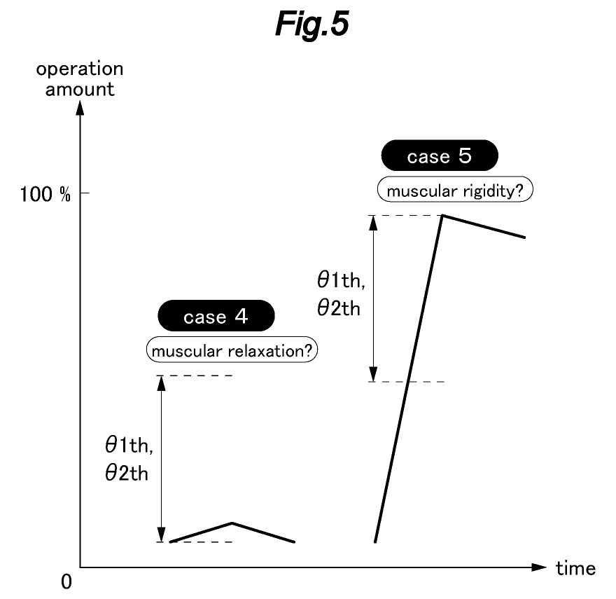

On the other hand, FIG. 5 is a time chart showing an example of an operation other than the specific operation. FIG. 5 shows operations for two cases, each of which does not satisfy the conditions of the specific operation. In either operation, an operation in the first direction is followed by an operation in the second direction. However, in an operation in Case 4, the operation amount of the operation in the first direction performed within the prescribed time period is less than the first operation amount threshold θ1th, and the operation amount of the operation in the second direction is less than the second operation amount threshold θ2th. In an operation in Case 5, the operation amount of the operation in the first direction performed within the prescribed time is equal to or greater than the first operation amount threshold θ1th, but the operation amount of the operation in the second direction is less than the second operation amount threshold θ2th. In the two cases, it is likely that both operations are intentionally performed by a driver in a normal state, but both operations may be performed due to the driver entering an abnormal state. In other words the operation in Case 4 may be performed due to the driver losing consciousness and becoming relaxed. The operation in Case 5 may be performed due to the driver experiencing a seizure and becoming rigid. Accordingly, the conditions for the specific operation are set so as to exclude the operations from the specific operation.

The condition for the specific operation is set so as to exclude operations that are performed due to the driver entering an abnormal state such as a seizure. Accordingly, as described above, the operation in the first direction and the operation in the second direction are defined as operations performed on a single operation member. For example, when the driver becomes rigid, the driver, after depressing the brake pedal 23, may lose contact with the brake pedal 23 and depress the accelerator pedal 22 instead. In this case, the release of the brake pedal 23 is identified as an operation in the first direction, and the depression of the accelerator pedal 22 is identified as an operation in the second direction, and the series of operations is not determined to satisfy the conditions of the specific operation.

Further, additional conditions may be set for the specific operation in addition to the above conditions. For example, a threshold value for the change amount of the operation in the first direction and a threshold value for the change amount of the operation in the second direction may be set for the specific operation. The change amount of the operation in the first direction and the second direction is the operation amount per unit time, that is, the operation speed, and both are expressed as positive values.

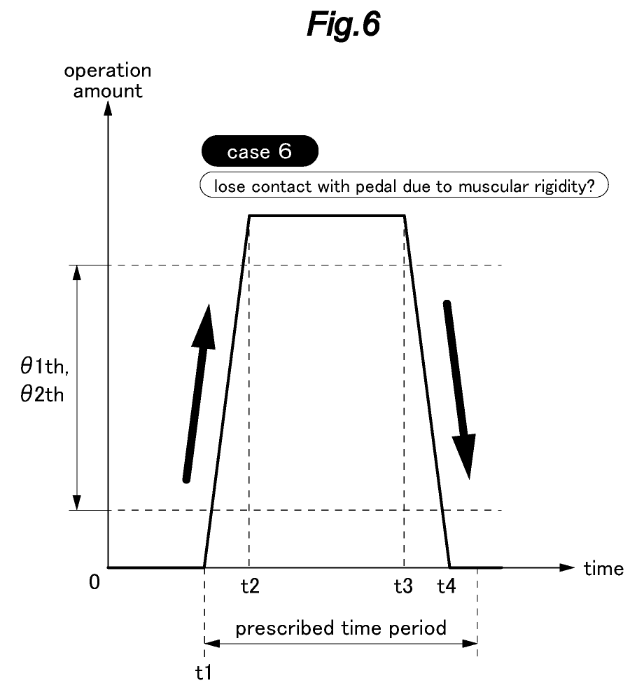

FIG. 6 is a time chart showing the operation amount for operations other than the specific operation. As shown in FIG. 6, in the operation of Case 6, similarly to the operation on the left side of FIG. 4, the operation in the first direction with an operation amount equal to or greater than the first operation amount threshold θ1th, and a subsequent operation in the second direction with an operation amount equal to or greater than the second operation amount threshold θ2th, are performed within the prescribed time period. However, such an operation may be performed due to the driver experiencing a seizure and becoming rigid, in which the pedal is depressed and then released due to the foot of the driver losing contact with the pedal.

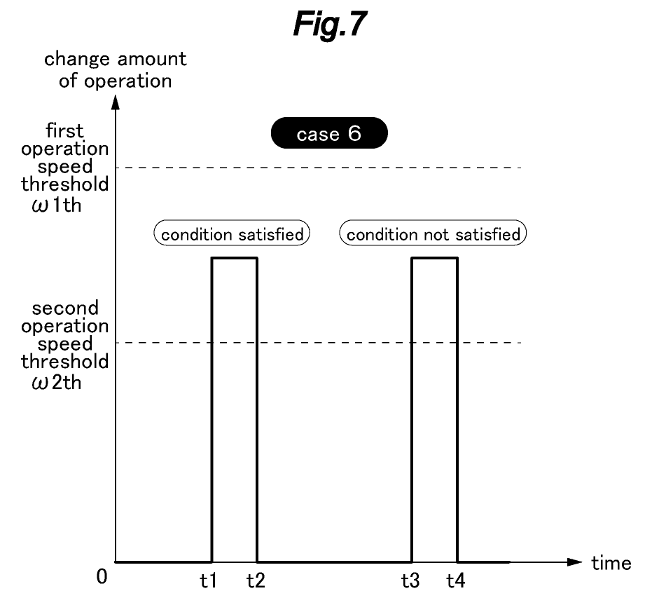

Accordingly, as described above, in addition to the threshold value of the operation amount, the threshold value of the operation speed is set as a condition for the specific operation FIG. 7 is a time chart showing the operation speed of the operation shown in FIG. 6. As shown in FIG. 7, for the operation speed of the operation in the first direction, the first operation speed threshold ω1th, which is a first change amount threshold, is set as an upper threshold. For the operation speed of the operation in the second direction, the second operation speed threshold ω2th, which is a second change amount threshold and is smaller than the first operation speed threshold ω1th, is set as the upper threshold. In the series of operations in Case 6, the operation speed of the operation in the first direction (the operation speed from time t1 to time t2) is less than the first operation speed threshold ω1th and the condition is satisfied, but the operation speed of the operation in the second direction (the operation speed from time t3 to time t4) is equal to or greater than the second operation speed threshold ω2th and the condition is not satisfied. Such an operation does not satisfy the above conditions and is therefore not detected as the specific operation.

By setting such conditions as the conditions for the specific operation, it is possible to accurately detect the specific operation which is likely to have been performed intentionally by the driver in a normal state.

Next, an example of the vehicle control procedure executed by the vehicle control device 1 will be described. Here, a case where level 1 or 2 autonomous driving control is performed will be described.

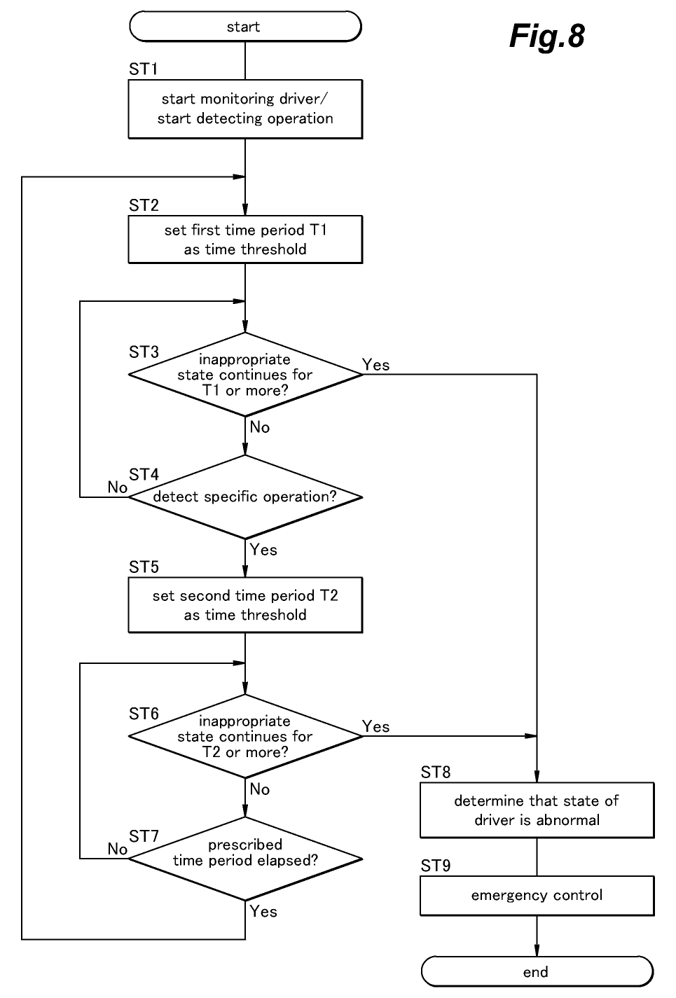

FIG. 8 is a flowchart showing the procedure for travel assistance control by the vehicle control device. When the ignition switch of the vehicle 2 is turned on, the vehicle control device 1 initiates the vehicle control shown in FIG. 8. First, the vehicle control device 1 starts monitoring the driver using the occupant monitoring device 18, and starts detecting the operation of each driving operation member of the driving operation device 17 (ST1). In monitoring the driver, the vehicle control device 1 recognizes the state of the driver using the occupant monitoring device 18 and determines whether the state of the driver is normal or abnormal. Further, the vehicle control device 1 determines whether the specific operation has been performed in detecting the operation of the driving operation member.

Next, the vehicle control device 1 sets the prescribed first time period T1 as the time threshold for the inappropriate state (ST2). The process of step ST2 may be performed before the process of step ST1.

After the processes of the steps ST1 and ST2, the vehicle control device 1 determines whether the inappropriate state of the driver continues for the first time period T1 or more (ST3). The count of the inappropriate state starts from the time point when the state of the driver is determined as the inappropriate state by the driver state determiner 56, and is reset when the state of the driver returns to the surrounding monitoring state (appropriate state).

The vehicle control device 1 proceeds to step ST4 when the inappropriate state of the driver has not continued for the first time period T1 or more (ST3: No), and proceeds to step ST8 when the inappropriate state of the driver has continued for the first time period T1 or more (ST3: Yes). In step ST4, the vehicle control device 1 determines whether the specific operation is detected by the operation detector 58. When the specific operation is not detected by the operation detector 58 (ST4: No), the vehicle control device 1 returns the process to step ST3.

On the other hand, when the specific operation is detected by the operation detector 58 (ST4: Yes), the vehicle control device 1 sets the second time period T2 as the time threshold of the inappropriate state (ST5). The second time period T2 is longer than the first time period T1. The second time period T2 may be a constant value, or may be a value that varies depending on the operation state, such as the mode of autonomous driving control by the travel controller 52 and the type and the operation amount of the detected specific operation.

After the process of step ST5, the vehicle control device 1 determines whether the inappropriate state of the driver continues for the second time period T2 or more (ST6). The count of the inappropriate state starts from the time point when the state of the driver is determined as the inappropriate state by the driver state determiner 56, and is reset when the state of the driver returns to the surrounding monitoring state (appropriate state).

When the inappropriate state of the driver has occurred before the process proceeds to step ST5, that is, before the specific operation is detected, the count started before the initiation of the driving assistance continues.

In the processing of step ST6, when the inappropriate state of the driver has not continued for the second time period T2 or more (No), the vehicle control device 1 determines whether the prescribed time period has elapsed from the time point when the specific operation was detected the (time point when ST4 became Yes) (ST7). The prescribed time period may be a constant value or may be a value that varies depending on the operation state, such as the mode of autonomous driving control by the travel controller 52 and the type and the operation amount of the detected specific operation.

When the prescribed time period has not elapsed from the time point when the specific operation is detected (ST7: No), the vehicle control device 1 returns the process to step ST6. On the other hand, when the prescribed time period has elapsed from the time point when the specific operation is detected (ST7: Yes), the vehicle control device 1 returns the process to step ST2 and sets the first time period T1 as the time threshold for the inappropriate state.

When the inappropriate state of the driver continues for the first time period T1 or more in step ST3 (Yes), and when the inappropriate state of the driver continues for the second time period T2 or more in step ST6 (Yes), the vehicle control device 1 determines that the state of the driver is abnormal (ST8). Thereafter, the vehicle control device 1 executes the above-mentioned emergency control (ST9).

The second time period T2, which is set as the time threshold in step ST5, is longer than the first time period T1, which is set as the time threshold in step ST2. In other words, when the specific operation is detected (ST4: Yes), unless the prescribed time period has elapsed (ST7: No), the time threshold is set greater than when the specific operation is not detected (ST4: No). Accordingly, the state of the driver is less likely to be determined as abnormal, and excessive determination of the abnormal state of the driver is suppressed.

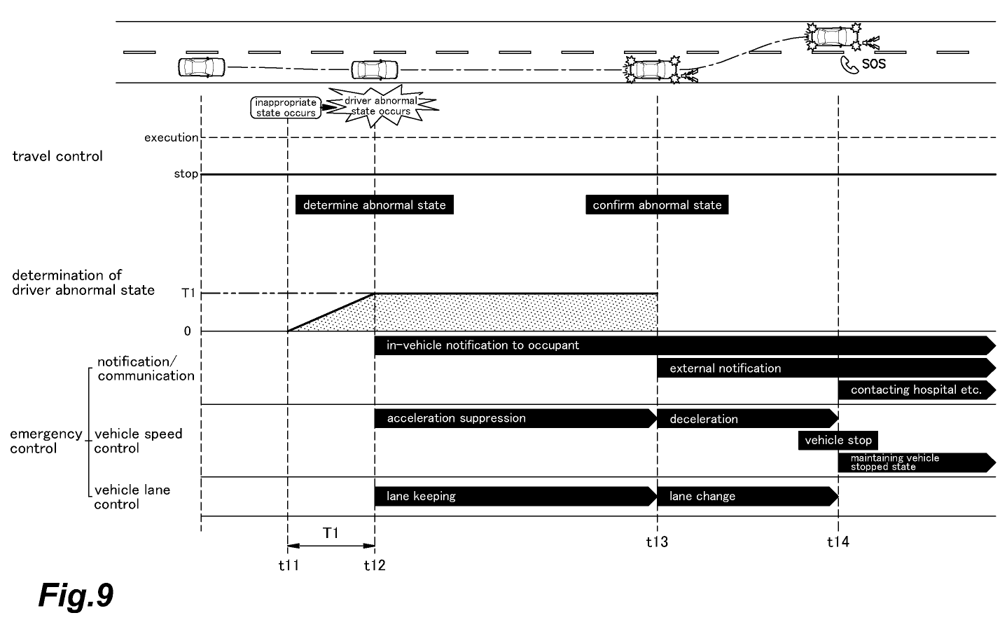

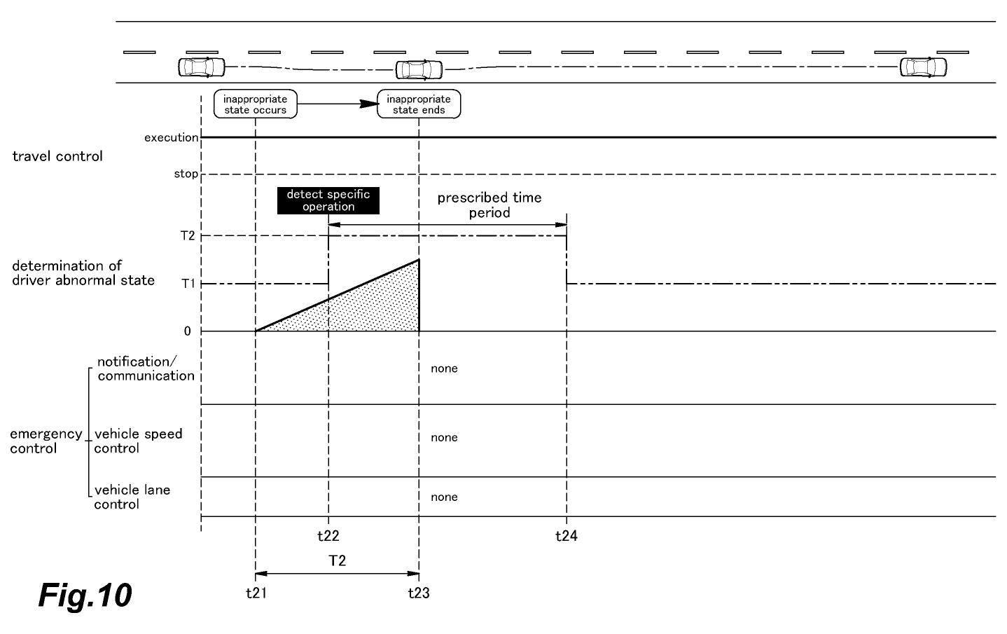

Next, the operation of the vehicle 2 in a case where the vehicle control device 1 executes such vehicle control will be described with reference to FIGS. 9 and 10.

FIG. 9 is a time chart showing an example of the travel assistance control when the vehicle control device 1 does not detect the specific operation. At a time point t11, the vehicle control device 1 determines that the state of the driver has changed from the appropriate state (surrounding monitoring state) in level 2 autonomous driving to the inappropriate state. Since the specific operation is not detected, the first time period T1 is set as the time threshold. At a time point t12 when the inappropriate state continues for the first time period T1, the vehicle control device 1 determines that the state of the driver is abnormal. Thereafter, the vehicle control device 1 executes the following controls: in-vehicle notification to the occupant, suppression of acceleration of the vehicle 2, and lane keeping control.

At a time point t13, when the inappropriate state of the driver continues for the prescribed time period despite the in-vehicle notification being issued, the vehicle control device 1 confirms the abnormal state of the driver. When the abnormal state is confirmed, the vehicle control device 1 executes the emergency controls including: external notification, deceleration of the vehicle 2, and lane change. At a time point t14, when the vehicle control device 1 brings the vehicle 2 to a stop in the travel lane or on the road shoulder, the vehicle control device 1 executes controls for contacting a hospital or the like and for maintaining the stopped state of the vehicle.

FIG. 10 is a time chart showing an example of travel assistance control when the vehicle control device 1 detects the specific operation. At a time point t21, the vehicle control device 1 determines that the state of the driver has changed from the appropriate state (surrounding monitoring state) in level 2 autonomous driving to the inappropriate state. At a time point t22, since the specific operation is detected, the second time period T2,which is longer than the first time period T1, is set as the time threshold. Since the second time period T2 is set as the time threshold, even if the inappropriate state continues over the first time period T1, the vehicle control device 1 does not determine that the state of the driver is abnormal. At a time point t23, before the second time period T2 elapses from the start of the inappropriate state, the state of the driver returns to the surrounding monitoring state (appropriate state), and the inappropriate state ends. As a result, the count is reset. At a time point t24, when the prescribed time period has elapsed from the time point t22 at which the specific operation was detected, the value of the time threshold is restored from the second time period T2 to the first time period T1.

Based on the detection of the specific operation, the value of the time threshold is changed from the first time period T1 to the second time period T2 that has been set longer, the state of the driver is less likely to be determined as abnormal. In this example, the inappropriate state does not continue for the second time period T2, which is longer than the first time period T1, the state of the driver is not determined as abnormal even after the first time period T1 has elapsed. Accordingly, excessive determination of the abnormal state of the driver is suppressed. If the inappropriate state continues over the second time period T2 the vehicle control device 1 determines that the state of the driver is abnormal when the second time period T2 has elapsed. Thereafter, the vehicle control device 1 executes the following controls: in-vehicle notification to the occupant, suppression of acceleration of the vehicle 2, and lane keeping control of the vehicle 2.

Accordingly, the vehicle control device 1 delays the activation of the notification, and delays the initiation of deceleration of the vehicle 2 and the stopping of the vehicle 2 when the specific operation is detected (FIG. 10 )as compared to when the specific operation is not detected (FIG. 9).

As described above, according to the vehicle control device 1 according to the embodiment, it is possible to suppress excessive determination of the abnormal state of the driver and appropriately determine the abnormal state of the driver based on whether the specific operation is detected.

The above embodiment is configured as follows.

A vehicle control device 1 includes: a driver state recognizer 55 configured to recognize a state of a driver of a vehicle 2, a driver state determiner 56 configured to determine that the state of the driver is abnormal when the state of the driver does not satisfy the prescribed suitability criteria based on a recognition result of the driver state recognizer 55; an operation detector 58 configured to detect an operation on a driving operation member which constitutes the driving operation device 17 of the vehicle 2; and a travel controller 52 configured to execute travel control of the vehicle 2 based on the operation detected by the operation detector 58 and a determination result of the driver state determiner 56. The driver state determiner 56 is configured to modify the suitability criteria so that the suitability criteria are relaxed in a case where the operation detector 58 detects a specific operation in which the driving operation member is operated in a first direction and then in a second direction opposite to the first direction.

When the specific operation that switches the operation direction of the driving operation member is performed, it is likely that the driver is in a normal state. For example, when the driver becomes rigid, the driver may depress the pedal strongly. When the driver becomes relaxed, the driver may release the depressed pedal. On the other hand, when the driver depresses and then releases the pedal (when the driver performs the specific operation), it is likely that the operations are performed intentionally by the driver, rather than being caused by rigidity or relaxation.

According to this aspect, when the specific operation is performed, the suitability criteria for determining the abnormal state are modified so that the suitability criteria are relaxed, thereby preventing excessive determination of the abnormal state of the driver and enabling a more appropriate determination of the abnormal state of the driver. This reduces notifications based on erroneous determinations, thereby improving the usability of the vehicle 2.

Preferably, the vehicle control device 1 further includes an emergency controller 54 configured to execute emergency control to decelerate and stop the vehicle 2 when the driver state determiner 56 determines that the state of the driver is abnormal. The driver state determiner 56 is configured to suspend the modification of the suitability criteria while the emergency control is being executed by the emergency controller 54.

According to this aspect, when the state of the driver is determined as abnormal and the emergency control is executed, the modified suitability criteria are restored to the original suitability criteria, thereby enabling the appropriate determination of the abnormal state of the driver while emergency control is being executed.

Preferably, the driving operation member is an accelerator pedal 22 or a brake pedal 23, the operation in the first direction is to depress the driving operation member, and the operation in the second direction is to release the driving operation member, and an operation speed of the operation (a change amount of the operation) in the second direction in the specific operation is equal to or less than a second operation speed threshold ω2th.

When the driver becomes rigid, the driver may depress the accelerator pedal 22 or the brake pedal 23 to the maximum extent, and then the foot of the driver may shift and lose contact with the pedal. In this case, the accelerator pedal 22 or the brake pedal 23 is released to the initial position. Such an operation is unlikely to be performed intentionally by the driver in a normal state. Accordingly, such operations should be excluded from the specific operation.

According to this aspect, by setting the second operation speed threshold ω2th for the operation amount of releasing the accelerator pedal 22 or the brake pedal 23, operations in which the accelerator pedal 22 or the brake pedal 23 is rapidly released to the initial position are excluded from the specific operation. This prevents the suitability criteria from being modified so that the suitability criteria are relaxed when such an operation is performed, thereby preventing a decrease in the determination accuracy of the abnormal state of the driver.

Preferably, the operation speed of the operation (the change amount of the operation) in the first direction in the specific operation is equal to or less than a first operation speed threshold ω1th, and the second operation speed threshold ω2th is smaller than the first operation speed threshold ω1th.

In normal driving operations, the accelerator pedal 22 or the brake pedal 23 may be depressed strongly, that is, may be depressed at a certain operating speed. Accordingly, it is not possible to determine the rigid state of the driver from such an operation. On the other hand, when the operation speed for releasing the pedal is high, it is likely due to the foot of the driver losing contact with the pedal, and in such a case, the state of the driver is likely to be abnormal, such as rigidity.

According to this aspect, since the second operation speed threshold ω2th, which is set for the operation speed for releasing the pedal, is smaller than the first operation speed threshold ω1th, operations due to the foot of the driver losing contact with the pedal can be excluded from the specific operation. This prevents the suitability criteria from being modified so that the suitability criteria are relaxed, thereby preventing a decrease in the determination accuracy of the abnormal state of the driver. The first operation speed threshold ω1th is also useful in preventing pedal misapplication.

Preferably, the operation speed of the operation in the first direction and the operation speed of the operation in the second direction are operation amounts per unit time.

According to this aspect, by setting different threshold values for the operation speed of the operation in the first direction and the operation speed of the operation in the second direction, it is possible to easily determine the operations that should be excluded from the specific operations. This increases the detection accuracy of the specific operation and reduces erroneous detection and erroneous notification.

Preferably, the driver state determiner 56 is configured to modify the suitability criteria so that the state of the driver is less likely to be determined as abnormal when the specific operation is performed.

According to this aspect, it is possible to suppress excessive determination of the abnormal state of the driver, and to more appropriately determine the abnormal state of the driver. This reduces notifications based on erroneous determinations, thereby improving the usability of the vehicle 2.

Preferably, the suitability criteria are that an inappropriate state, in which the state of the driver recognized by the driver state recognizer 55 does not satisfy a prescribed suitability condition, continues for a prescribed time threshold or more, and the driver state determiner 56 is configured to increase the time threshold when the specific operation is performed.

According to this aspect, when the specific operation is performed, by increasing the time threshold for determining the abnormal state of the driver, the state of the driver is less likely to be determined as abnormal. That is, it is possible to appropriately modify the time threshold for determining the abnormal state of the driver according to the operation on the driving operation member by the driver, and to appropriately determine the abnormal state of the driver.

Preferably, the driving operation member is a steering wheel 21, the operation in the first direction is one of a clockwise operation or a counterclockwise operation of the steering wheel 21, and the operation in the second direction is another of the clockwise operation or a counterclockwise operation of the steering wheel 21.

When the state of the driver is abnormal, the operation that switches the operation direction of the steering wheel 21 is rarely performed. In other words, when the operation that switches the operation direction of the steering wheel 21 is performed, it is likely that the driver in a normal state operates the steering wheel 21 intentionally.

According to this aspect, it is possible to appropriately modify the time threshold for determining the abnormal state of the driver according to the operation on the steering wheel 21 by the driver, and to appropriately determine the abnormal state of the driver.

According to another aspect, a vehicle control method includes: recognizing by a computer, a state of a driver of a vehicle 2; determining, by the computer, that the state of the driver is abnormal when the state of the driver does not satisfy a prescribed suitability criterion based on a recognition result of the computer; detecting, by the computer, an operation on a driving operation member of the vehicle 2; executing, by the computer, travel control of the vehicle 2 based on the operation detected by the computer and a determination result of the computer; and modifying, by the computer, the suitability criterion so that the suitability criterion is relaxed in a case where the computer detects a specific operation in which the driving operation member is operated in a first direction and then in a second direction opposite to the first direction.

According to another aspect, a non-transitory computer-readable storage medium comprising a control program, wherein the control program, when executed by a computer, executes a vehicle control method, includes: recognizing, by a computer, a state of a driver of a vehicle 2, determining, by the computer, that the state of the driver is abnormal when the state of the driver does not satisfy a prescribed suitability criterion based on a recognition result of the computer; detecting, by the computer, an operation on a driving operation member of the vehicle 2; executing, by the computer, travel control of the vehicle 2 based on the operation detected by the computer and a determination result of the computer; and modifying, by the computer, the suitability criterion so that the suitability criterion is relaxed in a case where the computer detects a specific operation in which the driving operation member is operated in a first direction and then in a second direction opposite to the first direction.

This concludes the explanation of the specific embodiment, but the present invention is not limited to the above embodiment or modified embodiment, and can be widely modified and implemented.

For example, in the above embodiment, when the specific operation is detected the driver state determiner 56 relaxes the suitability criteria by modifying the duration of the inappropriate state to a larger value. In another embodiment, when the specific operation is detected, the driver state determiner 56 may relax the suitability criteria by relaxing at least one of the prescribed conditions (suitability condition) of the suitability criteria. For example, the driver state determiner 56 may relax the suitability criteria by increasing the size of the prescribed area 37 shown in FIG. 3A.

Further, the specific structures, arrangements, quantities, and materials of each component or portion, as well as the specific contents and order of the processes, may be appropriately modified without departing from the scope of the present invention. Further, not all components shown in the above embodiments are essential, and those skilled in the art can select the components as appropriate.

1. A vehicle control device comprising:
a driver state recognizer configured to recognize a state of a driver of a vehicle,
a driver state determiner configured to determine that the state of the driver is abnormal when the state of the driver does not satisfy a prescribed suitability criterion based on a recognition result of the driver state recognizer;
an operation detector configured to detect an operation on a driving operation member of the vehicle; and
a travel controller configured to execute travel control of the vehicle based on the operation detected by the operation detector and a determination result of the driver state determiner, wherein
the driver state determiner is configured to modify the suitability criterion so that the suitability criterion is relaxed in a case where the operation detector detects a specific operation in which the driving operation member is operated in a first direction and then in a second direction opposite to the first direction.

2. The vehicle control device according to claim 1, further comprising an emergency controller configured to execute emergency control to decelerate and stop the vehicle when the driver state determiner determines that the state of the driver is abnormal, wherein
the driver state determiner is configured to suspend the modification of the suitability criterion while the emergency control is being executed by the emergency controller.

3. The vehicle control device according to claim 1, wherein
the driving operation member is an accelerator pedal or a brake pedal,
the operation in the first direction is to depress the driving operation member, and the operation in the second direction is to release the driving operation member, and
a change amount of the operation in the second direction in the specific operation is equal to or less than a second change amount threshold.

4. The vehicle control device according to claim 3, wherein
the change amount of the operation in the first direction in the specific operation is equal to or less than a first change amount threshold, and
the second change amount threshold is smaller than the first change amount threshold.

5. The vehicle control device according to claim 4, wherein the change amount of the operation in the first direction and the change amount of the operation in the second direction are operation amounts per unit time.

6. The vehicle control device according to claim 1, wherein the driver state determiner is configured to modify the suitability criterion so that the state of the driver is less likely to be determined as abnormal when the specific operation is performed.

7. The vehicle control device according to claim 6, wherein the suitability criterion is that an inappropriate state, in which the state of the driver recognized by the driver state recognizer does not satisfy a prescribed suitability condition, continues for a prescribed time threshold or more, and
the driver state determiner is configured to increase the time threshold when the specific operation is performed.

8. The vehicle control device according to claim 1, wherein
the driving operation member is a steering wheel,
the operation in the first direction is one of a clockwise operation or a counterclockwise operation of the steering wheel, and
the operation in the second direction is another of the clockwise operation or a counterclockwise operation of the steering wheel.

9. A vehicle control method comprising:
recognizing, by a computer, a state of a driver of a vehicle;
determining, by the computer, that the state of the driver is abnormal when the state of the driver does not satisfy a prescribed suitability criterion based on a recognition result of the computer;
detecting, by the computer, an operation on a driving operation member of the vehicle;
executing, by the computer, travel control of the vehicle based on the operation detected by the computer and a determination result of the computer; and
modifying, by the computer, the suitability criterion so that the suitability criterion is relaxed in a case where the computer detects a specific operation in which the driving operation member is operated in a first direction and then in a second direction opposite to the first direction.

10. A non-transitory computer-readable storage medium comprising a control program, wherein the control program, when executed by a computer, executes a vehicle control method, comprising:
recognizing, by the computer, a state of a driver of a vehicle;
determining, by the computer, that the state of the driver is abnormal when the state of the driver does not satisfy a prescribed suitability criterion based on a recognition result of the computer;
detecting, by the computer, an operation on a driving operation member of the vehicle;
executing, by the computer, travel control of the vehicle based on the operation detected by the computer and a determination result of the computer; and
modifying, by the computer, the suitability criterion so that the suitability criterion is relaxed in a case where the computer detects a specific operation in which the driving operation member is operated in a first direction and then in a second direction opposite to the first direction.
